(19) United States
(12) Patent Application Publication
(10) Pub. No.: US 2026/0075680 A1
(43) Pub. Date: Mar. 12, 2026

(54) SYSTEMS AND METHODS FOR MELTING FROZEN MATERIAL ON WINDSHIELDS FOR DASHBOARD CAMERAS OF PARKED VEHICLES

(71) Applicant: GM Global Technology Operations LLC, Detroit, MI (US)

(72) Inventors: Jihyun Kim, Incheon (KR); Jonghyun Kim, Incheon (KR); Yongbin Lee, Gimpo-si (KR); Jonglee Park, Novi, MI (US)

(73) Assignee: GM Global Technology Operations LLC, Detroit, MI (US)

(21) Appl. No.: 18/882,058

(22) Filed: Sep. 11, 2024

(51) Int. Cl. H05B 1/02; H05B 3/84

(52) U.S. Cl. CPC H05B 1/0236; H05B 3/84; H05B 2203/035

(57) ABSTRACT

A vehicle includes a windshield, a front-facing camera, a heating element, data processing hardware, and memory hardware. The camera is configured to capture image data through a portion of the windshield. The heating element is configured to locally heat the portion of the windshield. The memory hardware is in communication with the data processing hardware and stores instructions that, when executed on the data processing hardware, cause the data processing hardware to perform operations. The operations include determining whether frozen material is covering at least some of the portion of the windshield and, based on determining that frozen material is covering the at least some of the portion of the windshield, activating the heating element to locally heat the portion of the windshield to melt the frozen material covering the at least some of the portion of the windshield.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

In winter or cold weather conditions, frozen material (e.g., snow and/or ice) may accumulate on the windshield of a parked vehicle (e.g., an automobile, a truck, an airplane, a train, or a drone). In such cases, a camera of the vehicle may not be able to clearly capture images through the windshield and, thus, the camera may not be able to be used as a dashboard camera monitoring system while the vehicle is parked. Even when starting the vehicle to drive, time may be needed to remove material that has frozen onto the windshield near the camera.

The present disclosure relates generally to systems and methods for melting frozen material on windshields for dashboard cameras of parked vehicles.

### SUMMARY

One aspect of the disclosure provides a vehicle including a windshield, a front-facing camera, a heating element, data processing hardware, and memory hardware. The front-facing camera is configured to capture image data through a portion of the windshield, wherein the portion of the windshield is less than all of the windshield. The heating element is configured to locally heat the portion of the windshield. The memory hardware is in communication with the data processing hardware and stores instructions that, when executed on the data processing hardware, cause the data processing hardware to perform operations. The operations including determining whether frozen material is covering at least some of the portion of the windshield and, based on determining that frozen material is covering the at least some of the portion of the windshield, activating the heating element to locally heat the portion of the windshield to melt the frozen material covering the at least some of the portion of the windshield.

Implementations of the disclosure may include one or more of the following optional features. In some implementations, the heating element includes one or more infrared heating elements of the front-facing camera that are arranged around a lens of the front-facing camera. The one or more infrared heating elements are configured to emit infrared energy toward the portion of the windshield. In some examples, the heating element includes one or more layers of transparent conductive material embedded in, or implemented on, the portion of the windshield.

In some examples, determining that frozen material is covering the at least some of the portion of the windshield includes processing image data to detect frozen material. In some implementations, the heating element includes two or more heating zones. The operations may also include estimating a thickness of frozen material and selecting, based on the estimated thickness, one or more of the heating zones. Activating the heating element may include activating heating in the selected one or more heating zones.

In some implementations, the operations also include determining that an outside temperature satisfies a criterion and, based on determining that the outside temperature satisfies the criterion, initiating monitoring of the portion of the windshield for frozen material. In some examples, the operations also include determining that the vehicle is turned off and in park and, based on determining that the vehicle is turned off and in park, initiating monitoring of the portion of the windshield for frozen material. In some implementations, the operations also include determining that a battery level satisfies a criterion and, based on determining that the battery level satisfies the criterion, discontinuing determining whether frozen material is covering the at least some of the portion of the windshield, and de-activating the heating element.

In some examples, the vehicle also includes a cleaning element. The operations may also include determining that frozen material covering the at least some of the portion of the windshield has melted and, based on determining that frozen material covering the at least some of the portion of the windshield has melted, activating the cleaning element to remove melted material from the portion of the windshield. In some implementations, the operations also include determining that a temperature difference between an outside temperature and a temperature of the portion of the windshield satisfies a criterion and, based on the temperature difference satisfying the criterion, de-activating the heating element.

Another aspect of the disclosure provides a computer-implemented method that, when executed on data processing hardware, causes the data processing hardware to perform operations. The operations including obtaining image data from a front-facing camera of the vehicle, the front-facing camera configured to capture the image data through a portion of a windshield of the vehicle, wherein the portion of the windshield is less than all of the windshield. The operations also include processing the image data to determine whether frozen material is covering at least some of the portion of the windshield and, based on determining that frozen material is covering the at least some of the portion of the windshield, activating a heating element associated with the vehicle to locally heat the portion of the windshield to melt frozen material covering the at least some of the portion of the windshield.

Implementations of the disclosure may include one or more of the following optional features. In some implementations, the heating element includes one or more infrared heating elements of the front-facing camera that are arranged around a lens of the front-facing camera. The one or more infrared heating elements are configured to emit infrared energy toward the portion of the windshield. In some examples, the heating element includes one or more layers of transparent conductive material embedded in, or implemented on, the portion of the windshield.

In some examples, determining that frozen material is covering the at least some of the portion of the windshield includes processing image data to detect frozen material. In some implementations, the heating element includes two or more heating zones. The operations may also include estimating a thickness of frozen material and selecting, based on the estimated thickness, one or more of the heating zones. Activating the heating element may include activating heating in the selected one or more heating zones.

In some implementations, the operations also include determining that an outside temperature satisfies a criterion and, based on determining that the outside temperature satisfies the criterion, initiating monitoring of the portion of the windshield for frozen material. In some examples, the operations also include determining that the vehicle is turned off and in park and, based on determining that the vehicle is turned off and in park, initiating monitoring of the portion of the windshield for frozen material. In some implementations, the operations also include determining that a battery level satisfies a criterion and, based on determining that the battery level satisfies the criterion, discontinuing determining whether frozen material is covering the at least some of the portion of the windshield, and de-activating the heating element.

In some examples, the vehicle also includes a cleaning element, and the operations also include determining that frozen material is covering the at least some of the portion of the windshield has melted and, based on determining that frozen material is covering the at least some of the portion of the windshield has melted, activating the cleaning element to remove melted material from the portion of the windshield. In some implementations, the operations also include determining that a temperature difference between an outside temperature and a temperature of the portion of the windshield satisfies a criterion and, based on the temperature difference satisfying the criterion, de-activating the heating element.

### BRIEF DESCRIPTION OF THE DRAWINGS

The drawings described herein are for illustrative purposes only of selected configurations and are not intended to limit the scope of the present disclosure.

FIG. 1 is a view of an example vehicle incorporating a melting system for a dashboard camera in accordance with the principles of the present disclosure.

FIG. 2 is a schematic view of the vehicle and melting system of FIG. 1.

FIG. 3 is a perspective view of a dashboard camera mounted to a vehicle.

FIG. 4 is a perspective view of a camera incorporating a heating element.

FIG. 5A is a side view of a heating element embedded in a windshield.

FIG. 5B is a front view of the embedded heating element of FIG. 5A.

FIG. 6 illustrates example multiple heating regions associated with a dashboard camera.

FIG. 7A is a front view of a multiple-region heating element embedded in a windshield.

FIG. 7B is a side view of the embedded multiple-region heating element of FIG. 7A.

FIG. 8 is a flow chart of an example arrangement of operations for a method of locally melting frozen material on a windshield for a dashboard camera of a parked vehicle.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an application specific integrated circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, programmable logic devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA or an ASIC. Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

In winter or cold weather conditions, frozen material (e.g., snow and/or ice) may accumulate on the windshield of a parked vehicle (e.g., an automobile, a truck, an airplane, a train, or a drone). In such cases, a camera of the vehicle may not be able to clearly capture images through the windshield and, thus, the camera may not be able to be used as a dashboard camera monitoring system while the vehicle is parked and turned off. Therefore, the camera monitoring system may be unable to monitor activities around the vehicle. Even when starting the vehicle to drive, time may be needed to remove material that has frozen onto the windshield near the camera. Therefore, there is a need for improved systems and methods for melting frozen material on windshields for dashboard cameras of parked vehicles.

Disclosed embodiments include using one or more heating elements associated with a dashboard camera and/or a light detection and ranging (LiDAR) element to emit heat, which can remove frozen material while a vehicle is parked and turned off. This ensures that the camera can still function as the dashboard camera monitoring system while the vehicle is parked and turned off. Additionally, when starting to use the vehicle, the frozen material around the camera and LiDAR element will already have been melted, thus, providing clear visibility and enabling immediate use of the vehicle's camera and LiDAR functionality. Disclosed embodiments may also be used in connection with vehicle backup cameras, closed-circuit television (CCTV) cameras, security cameras, etc. While disclosed embodiments are described with regard to a front-facing dashboard camera, it should be understood that disclosed examples can be used in connection with other types of cameras and/or ranging devices facing other directions (e.g., sideward or rearward) and/or through other surfaces (e.g., other windows) of a vehicle.

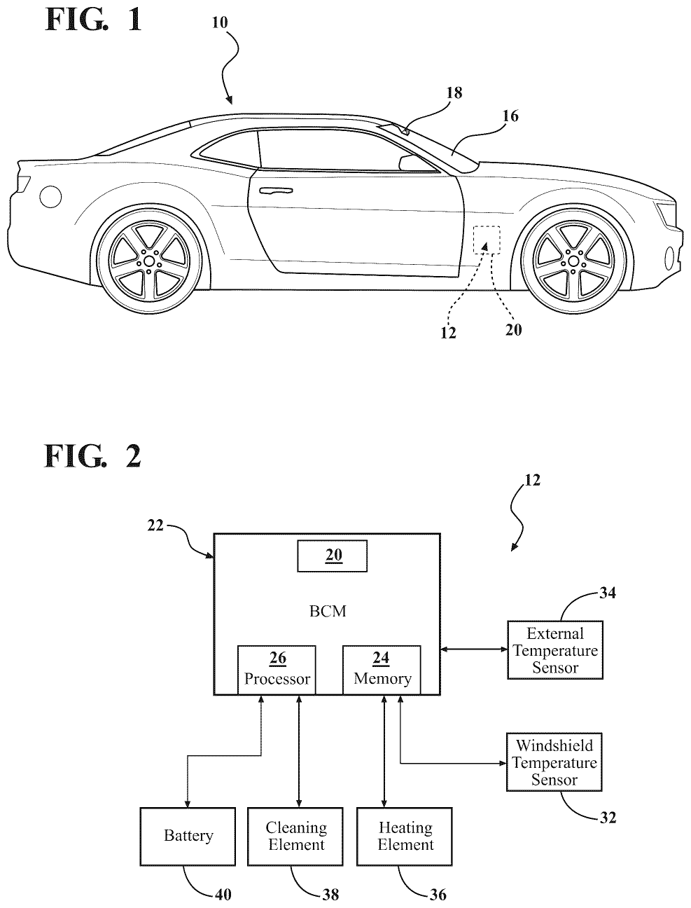

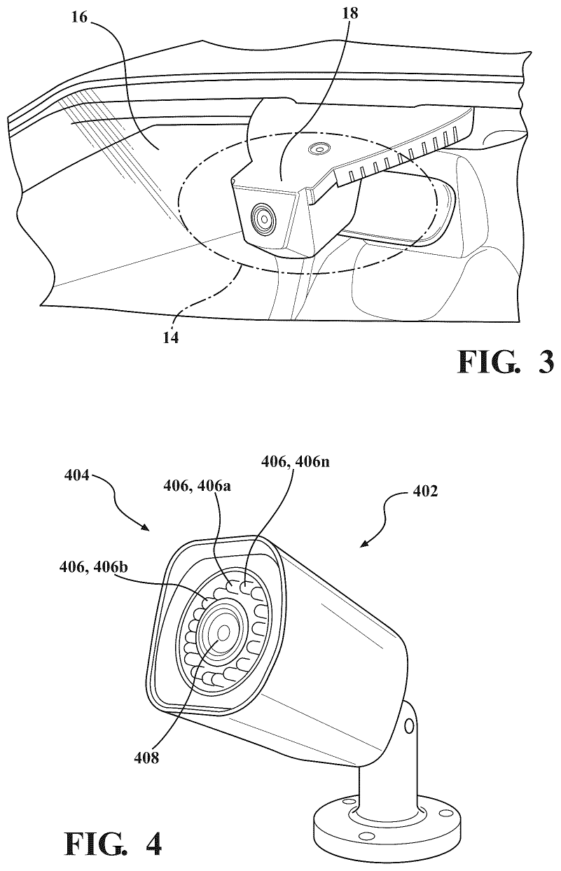

With particular reference to FIGS. 1 and 2, a vehicle 10 is shown in conjunction with a melting system 12. As will be described in greater detail below, the melting system 12 may be used to detect and melt frozen material on a portion 14 of a windshield 16 in a field of view (FOV) of a front-facing camera 18 (e.g., a dashboard camera) of the vehicle 10 (see FIG. 3) while the vehicle 10 is parked and turned off. Here, the camera 18 is configured to capture image data through the portion 14 of the windshield 16, and the portion 14 is less than all of the windshield 16.

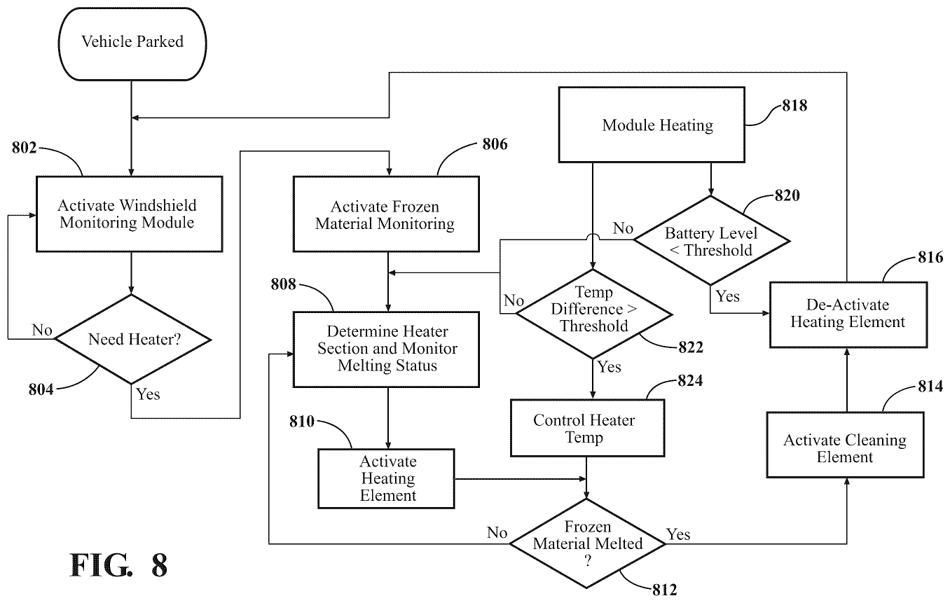

The melting system 12 includes a windshield monitoring module 20 that may be stored and executed by a body control module (BCM) 22 of the vehicle 10. Specifically, the BCM 22 may store instructions for executing the operations shown in FIG. 8, for example, on memory hardware 24, which may be executed by data processing hardware (e.g., a processor 26) of the BCM 22 to perform the operations.

In the illustrated example, the windshield monitoring module 20 is in communication with a windshield temperature sensor 32, an external temperature sensor 34, the camera 18, a heating element 36 associated with the camera 18 and, in some examples, a cleaning element 38 associated with the camera 18. In some implementations, the windshield monitoring module 20 uses information from the windshield temperature sensor 32, the external temperature sensor 34, and/or the camera 18 to detect frozen material on at least some of the portion 14 of the windshield 16. In some examples, the windshield monitoring module 20 processes image data captured by the camera 18 to detect frozen material by, for example, detecting an inability to focus, detecting blurry image data, detecting a consistent color (e.g., white or gray) across the portion 14 of the windshield 16, etc. Additionally or alternatively, the windshield monitoring module 20 may obtain information indicating a likelihood of frozen material on the windshield 16 (e.g., a weather prediction or a recorded amount of precipitation) from a vehicle assistance program (e.g., OnStar®). In some implementations, the windshield monitoring module 20 activates monitoring for frozen material when the vehicle 10 is parked and turned off, and an outside temperature measured by the external temperature sensor 34 satisfies a criterion (e.g., the outside temperature is below freezing).

When frozen material is detected on at least some of the portion 14 of the windshield 16, the windshield monitoring module 20 activates the heating element 36 to melt the frozen material from the portion 14 of the windshield 16. Here, the heating element 36 is configured to locally heat the portion 14 of the windshield 16. In some examples, a shape of the heating element 36 is selected based upon a shape or contour of the windshield 16 and/or an orientation of the heating element 36 relative to an orientation of the windshield 16. In some implementations, while the heating element 36 is active, the windshield monitoring module 20 determines whether a battery level of a battery 40 of the vehicle 10 satisfies a criterion (e.g., the battery level has fallen below a threshold level) and, based on determining that the battery level satisfies the criterion, discontinue determining whether frozen material is covering the at least some of the portion 14 of the windshield 16, and de-activates the heating element 36. Additionally or alternatively, the windshield monitoring module 20 monitors a temperature difference between a windshield temperature measured by the windshield temperature sensor 32 and an outside temperature measured by the external temperature sensor 34 to determine that the temperature difference satisfies a criterion and, based on the difference satisfying the criterion, de-activates the heating element 36 to, for example, avoid damaging the windshield 16 (e.g., cracking the windshield 16).

In some implementations, the windshield monitoring module 20 also detects whether the frozen material has melted and, based on determining that the frozen material has melted, activates the cleaning element 38 to remove the melted material (e.g., droplets of water) from the portion 14 of the windshield 16. The windshield monitoring module 20 may also determine that the melted material has been substantially removed from the portion of the windshield and, based on determining that the melted material has been substantially removed from the portion of the windshield, de-activate the cleaning element 38. In some examples, the windshield monitoring module 20 processes image data collected by the camera 18 to determine that the melted material has been removed from the portion of the windshield. Example cleaning elements 38 include, but are not limited to, an electrowetting element and an ultrasonic element.

FIG. 4 is a perspective view of an example camera 402 incorporating an example heating element 404. In the illustrated example, the heating element 404 includes one or more infrared heating elements 406, 406a-n that are arranged around a lens 408 of the camera 402. For example, the infrared heating elements 406 may be arranged in one or more rings around the lens 408. Here, the infrared heating elements 406 are configured to emit infrared energy locally toward the portion 14 of the windshield 16.

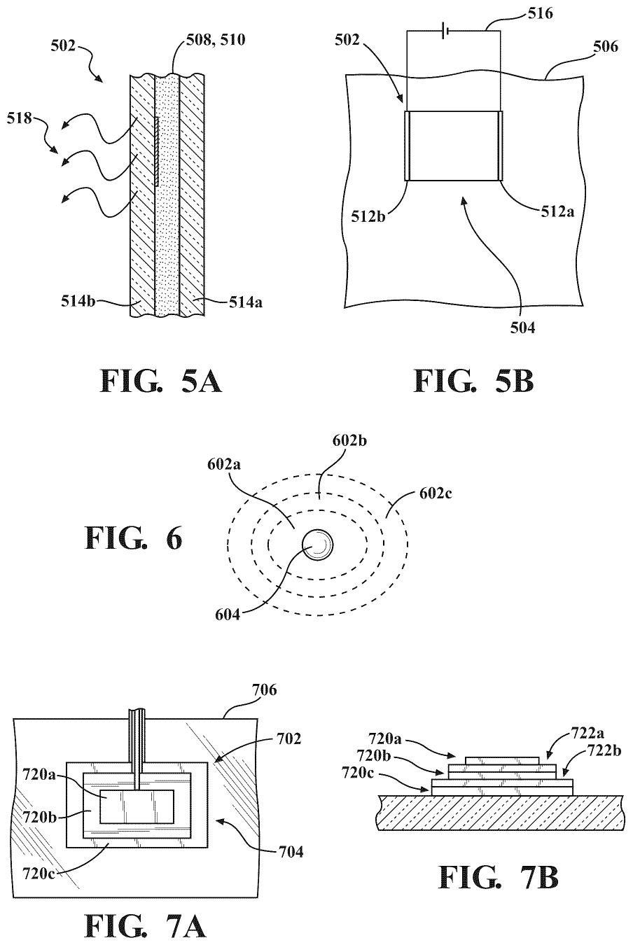

FIG. 5A is a side view of an example heating element 502 that is embedded in a portion 504 of a windshield 506. FIG. 5B is a front view of the embedded heating element 502 of FIG. 5A. In the illustrated example, the heating element 502 includes a layer of transparent conductive material 508 embedded in the portion 504 of the windshield 506. In some implementations, the layer of transparent conductive material 508 includes a layer of polyvinyl butyral 510 connected on each end to a respective electrical bus 512a, 512b, and sandwiched between two layers of glass 514a and 514b. Here, the respective electrical busses 512 are connected to respective terminals of a power source 516 (e.g., the battery 40). When the power source 516 is activated or connected to the electrical busses 512, the heating element 502 emits heat 518 that locally heats the portion 504 of the windshield 506.

In some implementations, the windshield monitoring module 20 estimates a thickness of frozen material on the portion 14 of the windshield 16 and selects, based on the estimated thickness, one or more of the heating zones 602a, 602b, 602c (see FIG. 6) that will be used to melt the frozen material. Here, as the estimated thickness increases, the windshield monitoring module 20 activates heating over a larger area of the windshield 16 by selecting and activating heating in additional heating zones 602. In the illustrated example, the heating zones 602 are concentric heating zones that surround a lens 604 of the camera 18.

FIG. 7A is a top view of an example heating element 702 that is embedded in, or implemented on, a portion 704 of a windshield 706 and implements a plurality of heating zones 720a, 720b, and 720c. FIG. 7B is a side view of the embedded heating element 702 of FIG. 7A. In the illustrated example, the heating element 702 includes a plurality of layers of transparent conductive material layers 708a, 708b, and 708c that are embedded in, or implemented on, the portion 704 of the windshield 706. In the illustrated example, the layers 708 overlap, and each layer 708 corresponds to one of the heating zones 720. Additionally or alternatively, the layers 708 may not overlap. In some implementations, each layer of transparent conductive material layer 708 includes a corresponding layer of polyvinyl butyral connected on each end to a respective electrical bus and isolated from adjacent layers of polyvinyl butyral by a layer of electrically insulating material 722, 722a-n.

FIG. 8 is a flowchart of an exemplary arrangement of operations for a computer-implemented method 800 of locally melting frozen material on a portion of a windshield for a dashboard camera of a parked vehicle. The operations may be performed by data processing hardware (e.g., the processor 26 of FIG. 1) based on executing instructions stored on memory hardware (e.g., the memory 24 of FIG. 1).

The example method 800 starts when the vehicle 10 is put in park and turned off. At operation 802, the method 800 activates the windshield monitoring module 20. In some examples, the method 800 automatically activates the windshield monitoring module 20 when the vehicle is parked and turned off. Additionally or alternatively, a driver of the vehicle 10 may manually activate the windshield monitoring module 20 using a control of the vehicle 10 before turning the vehicle 10 off or remotely using a key fob.

At operation 804, the windshield monitoring module 20 determines whether local heating of the portion 14 of the windshield 16 may be required by, for example, determining that an outside temperature measured by the external temperature sensor 34 satisfies a criterion (e.g., is below freezing). If heating of the portion 14 of the windshield 16 may be required, then the windshield monitoring module 20 begins, at operation 806, obtaining image data from the camera 18, and processing the image data captured by the camera 18 to determine whether there is frozen material covering at least some of the portion 14 of the windshield. Additionally or alternatively, the windshield monitoring module 20 may obtain information indicating a likelihood of frozen material on the windshield 16 (e.g., a weather prediction or a recorded amount of precipitation) via a vehicle assistance program (e.g., OnStar®).

At operation 808, the method 800 includes, determining whether frozen material is, or is likely, covering at least some of the portion 14 of the windshield 16. At operation 810, the method 800 includes, based on determining that frozen material is covering the at least some of the portion 14 of the windshield 16 at operation 808, activating the heating element 36 associated with the vehicle 10 to locally heat the portion 14 of the windshield 16 to melt the frozen material covering the at least some of the portion 14 of the windshield 16.

If, at operation 812, the frozen material has melted, then the method 800 at operation 814 activates the cleaning element 38 and at operation 816 de-activates the heating element 36. Control then returns to operation 802.

At operation 818, the method 800, when the heating element 36 is activated, initiates monitoring of the heating of the portion 14 of the windshield 16. At operation 820, the method 800 determines whether a battery level of the battery 40 satisfies a criterion (e.g., the battery level falls below a threshold level). Based on determining that the battery level satisfies the criterion at operation 820, the method 800, at operation 816, de-activates the heating element 36.

At operation 822, the method 800 determines whether a temperature difference between a windshield temperature in the portion 14 measured by the windshield temperature sensor 32 and an outside temperature measured by the external temperature sensor 34 satisfies a criterion (e.g., the temperature difference is greater than a threshold difference). Based on determining that the temperature difference satisfies the criterion at operation 822, the method 800, at operation 824, de-activates the heating element 36 or decreases an amount of heat generated by the heating element 36 to, for example, avoid damaging the windshield 16 (e.g., cracking the windshield 16).

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a windshield;
a front-facing camera configured to capture image data through a portion of the windshield, wherein the portion of the windshield is less than all of the windshield;
a heating element configured to locally heat the portion of the windshield;
data processing hardware; and
memory hardware in communication with the data processing hardware, the memory hardware storing instructions that, when executed on the data processing hardware, cause the data processing hardware to perform operations comprising:
determining whether frozen material is covering at least some of the portion of the windshield; and
based on determining that frozen material is covering the at least some of the portion of the windshield, activating the heating element to locally heat the portion of the windshield to melt the frozen material covering the at least some of the portion of the windshield.

2. The vehicle of claim 1, wherein:
the heating element comprises one or more infrared heating elements of the front-facing camera that are arranged around a lens of the front-facing camera; and
the one or more infrared heating elements are configured to emit infrared energy toward the portion of the windshield.

3. The vehicle of claim 1, wherein the heating element comprises one or more layers of transparent conductive material embedded in, or implemented on, the portion of the windshield.

4. The vehicle of claim 1, wherein determining that frozen material is covering the at least some of the portion of the windshield comprises processing image data to detect frozen material.

5. The vehicle of claim 1, wherein:
the heating element comprises two or more heating zones;
the operations further comprise:
estimating a thickness of frozen material; and
selecting, based on the estimated thickness, one or more of the heating zones; and
activating the heating element comprises activating heating in the selected one or more heating zones.

6. The vehicle of claim 1, wherein the operations further comprise:
determining that an outside temperature satisfies a criterion; and
based on determining that the outside temperature satisfies the criterion, initiating monitoring of the portion of the windshield for frozen material.

7. The vehicle of claim 1, wherein the operations further comprise:
determining that the vehicle is turned off and in park; and
based on determining that the vehicle is turned off and in park, initiating monitoring of the portion of the windshield for frozen material.

8. The vehicle of claim 1, wherein the operations further comprise:
determining that a battery level satisfies a criterion; and
based on determining that the battery level satisfies the criterion:
discontinuing determining whether frozen material is covering the at least some of the portion of the windshield; and
de-activating the heating element.

9. The vehicle of claim 1, further comprising a cleaning element, wherein the operations further comprise:
determining that frozen material is covering the at least some of the portion of the windshield has melted; and
based on determining that frozen material is covering the at least some of the portion of the windshield has melted, activating the cleaning element to remove melted material from the portion of the windshield.

10. The vehicle of claim 1, wherein the operations further comprise:
determining that a temperature difference between an outside temperature and a temperature of the portion of the windshield satisfies a criterion; and
based on the temperature difference satisfying the criterion, de-activating the heating element.

11. A computer-implemented method executed on data processing hardware of a vehicle that causes the data processing hardware to perform operations comprising:
obtaining image data from a front-facing camera of the vehicle, the front-facing camera configured to capture the image data through a portion of a windshield of the vehicle, wherein the portion of the windshield is less than all of the windshield;
processing the image data to determine whether frozen material is covering at least some of the portion of the windshield; and
based on determining that frozen material is covering the at least some of the portion of the windshield, activating a heating element associated with the vehicle to locally heat the portion of the windshield to melt frozen material covering the at least some of the portion of the windshield.

12. The computer-implemented method of claim 11, wherein:
the heating element comprises one or more infrared heating elements of the front-facing camera that are arranged around a lens of the front-facing camera; and
the one or more infrared heating elements are configured to emit infrared energy toward the portion of the windshield.

13. The computer-implemented method of claim 11, wherein the heating element comprises one or more layers of transparent conductive material embedded in, or implemented on, the portion of the windshield.

14. The computer-implemented method of claim 11, wherein determining that frozen material is covering the at least some of the portion of the windshield comprises processing image data to detect frozen material.

15. The computer-implemented method of claim 11, wherein:
the heating element comprises two or more heating zones;
the operations further comprise:
estimating a thickness of frozen material; and
selecting, based on the estimated thickness, one or more of the heating zones; and
activating the heating element comprises activating heating in the selected one or more heating zones.

16. The computer-implemented method of claim 11, wherein the operations further comprise:
determining that an outside temperature satisfies a criterion; and
based on determining that the outside temperature satisfies the criterion, initiating monitoring of the portion of the windshield for frozen material.

17. The computer-implemented method of claim 11, wherein the operations further comprise:
determining that the vehicle is turned off and in park; and
based on determining that the vehicle is turned off and in park, initiating monitoring of the portion of the windshield for frozen material.

18. The computer-implemented method of claim 11, wherein the operations further comprise:
determining that a battery level satisfies a criterion; and
based on determining that the battery level satisfies the criterion:
discontinuing determining whether frozen material is covering the at least some of the portion of the windshield; and
de-activating the heating element.

19. The computer-implemented method of claim 11, further comprising a cleaning element, wherein the operations further comprise:
determining that frozen material is covering the at least some of the portion of the windshield has melted; and
based on determining that frozen material is covering the at least some of the portion of the windshield has melted, activating the cleaning element to remove droplets of water from the portion of the windshield.

20. The computer-implemented method of claim 11, wherein the operations further comprise:
determining that a temperature difference between an outside temperature and a temperature of the portion of the windshield satisfies a criterion; and
based on the temperature difference satisfying the criterion, de-activating the heating element.
